(19) United States
(12) Patent Application Publication
(10) Pub. No.: US 2009/0084779 A1
(43) Pub. Date: Apr. 2, 2009

(54) Microwave water heating system

(76) Inventor: Vincent A. Bravo, Haskell, NJ (US)

Correspondence Address: Herten, Burstein, Sheridan, Cevasco, Bottinelli,;Litt & Harz, L.L.C., Third Floor, 21 Main Street, Court Plaza South, Hackensack, NJ, 07601, US

(21) Appl. No.: 11/904,828

(22) Filed: Sep. 28, 2007

(51) Int. Cl. H05B 6/80; F24H 1/22

(52) U.S. Cl. 219/688

(57) ABSTRACT

A water heating system includes a heat exchange chamber having an internal cavity and a water coil within the internal cavity of the heat exchange chamber. A magnetron generates microwave energy and is in communication with the internal cavity. A hot air control system draws the heat generated by the magnetron into the internal cavity. The hot air control system includes a valve which is selectively opened and closed to control the passage of the heat generated by the magnetron through the internal cavity.

### BACKGROUND OF THE INVENTION

1. Field of the Invention

The invention relates to a water heating system. In particular, the invention relates to a water heating system employing microwave energy within a selectively opened/closed system to heat a water reservoir.

2. Description of the Related Art

As those skilled in the art certainly appreciate, water heating systems employing microwave energy in the heating process are known in the art. However, these systems are limited in ability and, accordingly, have yet to gain popularity in the marketplace.

With this in mind, a need continues to exist for a water heating system employing microwave energy in a reliable, efficient and cost effective manner. The present invention provides such a system.

### SUMMARY OF THE INVENTION

It is, therefore, an object of the present invention to provide a water heating system including a heat exchange chamber having an internal cavity and a water coil within the internal cavity of the heat exchange chamber. A magnetron generates microwave energy and is in communication with the internal cavity. A hot air control system draws the heat generated by the magnetron into the internal cavity. The hot air control system includes a valve which is selectively opened and closed to control the passage of the heat generated by the magnetron through the internal cavity.

It is also an object of the present invention to provide a water heating system including a microwave stirring fan distributing microwave energy generated by the magnetron.

It is also another object of the present invention to provide a water heating system wherein the water coil includes an inlet and an outlet, and temperature sensors are respectively positioned at the inlet and outlet for monitoring water temperatures.

It is also a further object of the present invention to provide a water heating system including a microprocessor controlling operation of the water heating system.

It is still another object of the present invention to provide a water heating system wherein the water coil is helically oriented within the internal cavity.

It is yet another object of the present invention to provide a water heating system wherein the water coil is composed of PTFE tubing.

It is a further object of the present invention to provide a water heating system wherein the valve is a butterfly valve.

It is still a further object of the present invention to provide a water heating system wherein a solenoid controls the valve.

It is also an object of the present invention to provide a water heating system wherein the valve is opened when the magnetron is powered on generating microwave energy and the valve is closed when the magnetron is powered off.

It is also another object of the present invention to provide a water heating system wherein the magnetron is coupled to a wave guide which directs the microwave energy from the magnetron to the internal cavity.

It is also an object of the present invention to provide a water heating system wherein the wave guide includes an inlet end coupled to the magnetron and an outlet end to which a microwave stirring fan is coupled for distributing microwave energy as it enters the internal cavity.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a perspective view of the present microwave water heating system.

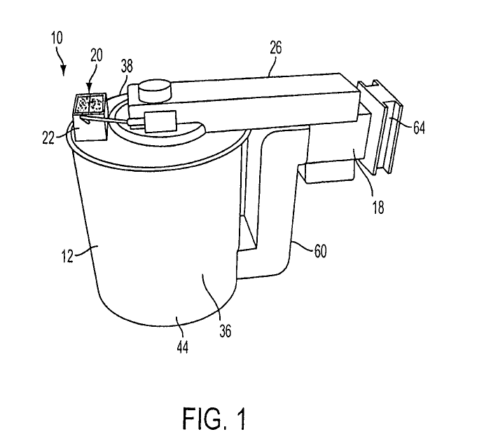

FIG. 2 is cross sectional schematic of the present microwave heating system.

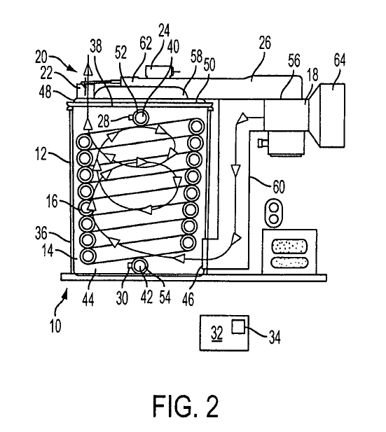

FIGS. 3 and 4 are cross sectional schematic representations showing operation of the present water heating system respectively during an on cycle and an off cycle.

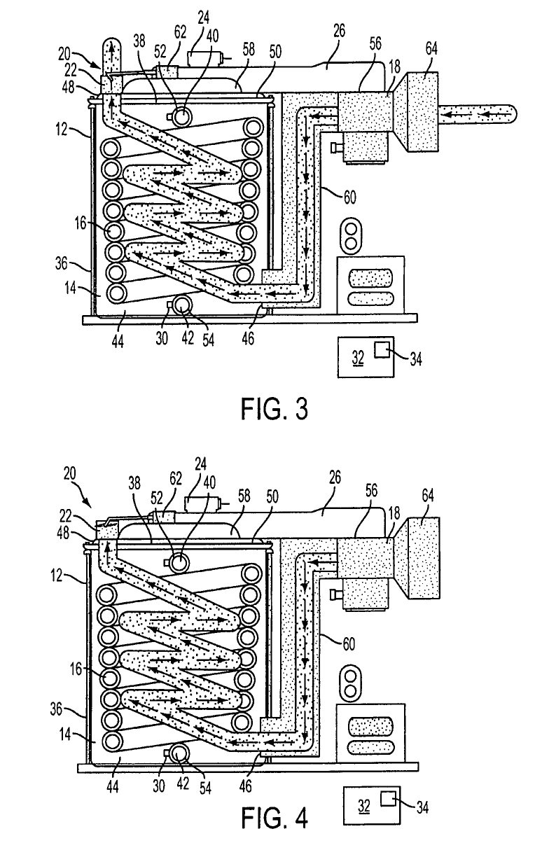

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as a basis for teaching one skilled in the art how to make and/or use the invention.

Referring to the various figures, a microwave water heating system 10 is disclosed. The present water heating system 10 is well suited for a variety of applications, including, but not limited to, providing hot water for showers, baths, kitchen and other personal uses, and providing hot water for heating rooms within a house or other building structure.

The microwave water heating system 10 includes a heat exchange chamber 12 having an internal cavity 14. A water coil 16 is positioned within the internal cavity 14 of the heat exchange chamber 12. A magnetron 18 generating microwave energy is in communication with the internal cavity 14. A hot air control system 20 draws the heat generated by the magnetron 18 into the internal cavity 14. The hot air control system 20 includes a valve 22 which is selectively opened and closed to control the passage of the heat generated by the magnetron 18 through the internal cavity 14.

In accordance with the present invention, water is heated directly on the molecular level by RF microwave energy generated by a magnetron 18. This action is aided by the use of a microwave-stirring fan 24 to maintain even heating in the heat exchange chamber 12. The magnetron 18 is mounted to the side of the heat exchange chamber 12 via a wave guide 26 to provide efficient cooling.

Efficiency is enhanced by directing the hot air from the cooling of the magnetron 18 into the heat exchange chamber 12. In addition, inlet and outlet water temperatures are monitored by an inlet sensor 28 and an outlet sensor 30. These temperatures are further controlled by a microprocessor 32 to maintain efficient operating conditions. The microprocessor 32 also monitors and controls the magnetron 18 temperature and water pressure. The water heating system 10 will shut down if either of these conditions is beyond acceptable limits. The microwave water heating system 10 further includes a digital display 34 that indicates the cause of any shut down. Ultimately, since the water is heated directly through the application of microwave energy, there is no loss through a heat exchanger, either during heating or during the off cycle. As a result, very little residual heat is lost during the off cycle.

More particularly, the present microwave water heating system 10 includes a heat exchange chamber 12. In accordance with a preferred embodiment, the heat exchange chamber 12 includes an internal cavity 14. The internal cavity 14 is encased by sidewalls 36 and a top wall 38. Various inlets and outlets are formed in the sidewall 36 and top wall 38 of the heat exchange chamber 12 to facilitate the flow of microwave energy and heat into and out of the heat exchange chamber 12. In particular, the heat exchange chamber 12 includes a water inlet aperture 40 in the top wall 38 thereof and a water outlet aperture 42 adjacent the base 44 of the heat exchange chamber 12. The heat exchange chamber 12 also includes a heat inlet aperture 46 in a sidewall 36 adjacent the base 44 of the heat exchange chamber 12, a heat outlet aperture 48 in the top wall 38 of the heat exchange chamber 12, and a microwave inlet aperture 50 in the top wall 38 of the heat exchange chamber 12.

The heat exchange chamber 12 includes a water coil 16. The water coil 16 is helically oriented within the internal cavity 14 of the heat exchange chamber 12. The water coil 16 includes an inlet 52 coupled to heat exchange chamber 12 at the water inlet aperture 40 and an outlet 54 coupled to the heat exchange chamber 12 at the water outlet aperture 42. The water coil 16 provides for the passage of water through the internal cavity 14 of the heat exchange chamber 12. In accordance with a preferred embodiment, the water coil 16 is composed of PTFE (that is, TEFLON) tubing which conducts very little heat.

In practice, the water is supplied from a water source to the inlet 52. After the water passes through the internal cavity 14, the heated water exits the internal cavity 14 through the outlet 54 and continues to its final destination. The water is heated in two ways. First, the water is heated via microwave energy. The microwave energy is generated by a magnetron 18 in communication with the internal cavity 14 of the heat exchange chamber 12. The microwave energy generated by the magnetron 18 is directed to the internal cavity 14 of the heat exchange chamber 12 via a wave guide 26. The wave guide 26 includes an inlet end 56 and an outlet end 58 coupled to the microwave inlet aperture 50 of the heat exchange chamber 12. At the outlet end 58 of the wave guide 26, a stirring fan 24 is provided. The stirring fan 24 distributes the microwave energy within the internal cavity 14 of the heat exchange chamber 12 in a manner providing even distribution of the microwave energy within the internal cavity 14.

Heat is also provided to the water passing through the water coil 16 via a hot air control system 20. In accordance with the hot air control system 20, a fan 64 draws ambient air over the magnetron 18 when the magnetron 18 is on. This air exits the magnetron 18 and enters a passageway 60 directing it to the heat inlet aperture 46 in the base 44 of the heat exchange chamber 12. The heated ambient air is then passed through the internal cavity 14 of the heat exchange chamber 12 and is brought into contact with the water coil 16 transporting the water within the internal cavity 14.

This hot air adds to the efficiency of the present microwave water heating system 10 by utilizing the heat generated by the magnetron 18 to assist in the heating of water. That is, both the heat and the microwave energy generated by the magnetron 18 are passed on to the water for efficiently heating it within the heat exchange chamber 12.

The efficiency of the system is further improved by providing the heat outlet aperture 48 in the top wall 38 of the heat exchange chamber 12 with a butterfly valve 22. The butterfly valve 22 is used to selectively open and close the internal cavity 14 of the heat exchange chamber 12 for the escape of hot air within the internal cavity 14. Briefly, when the magnetron 18 is powered on (that is, the on cycle), and a constant flow of hot air is forced into the internal cavity 14 of the heat exchange chamber 12, the butterfly valve 22 is opened allowing for a regular flow of the hot air through the internal cavity 14 for heating the water passing therethrough. However, when the magnetron 18 is turned off (that is, the off cycle), the fan 64 is also turned off and ceases to pull ambient air over the magnetron 18. The hot air is then maintained within the internal cavity 14. This is achieved by closing the butterfly valve 22 and maintaining the hot air within the internal cavity 14. Since the hot air is maintained within the internal cavity 14, the heat is not lost to the external environment. Loss of the heat is further prevented by insulating the sidewalls 36 and top wall 38 of the heat exchange chamber 12 in a manner efficiently controlling heat exchange with the external environment.

As briefly discussed above, and with reference to the various figures, operation of the present heat recovery system is achieved in the following manner. When the magnetron 18 powered is on, ambient air is forced over the magnetron 18 by a fan 64 and the heat that is removed from the magnetron 18 by the passage of ambient air is touted into the internal cavity 14 of the heat exchange chamber 12. The butterfly valve 22 is opened by the solenoid 62 allowing the flow of heat through the heat exchange chamber 12. At this point, the hot air flow through the internal cavity 14 of the heat exchange chamber 12 augments the heat induced into the water within the water coil 16 by the microwave field.

When the magnetron 18 power is turned off between heat cycles, the heat is trapped within the heat exchange chamber 12 by the butterfly valve 22 which is closed by the solenoid 62. The heat maintains the temperature of the water in the water coil 16 at a higher level. The next heat cycle is then started at this temperature allowing for a faster heat cycle and much less power being used.

The present microwave water heating system 10 augments the primary heating mechanism, that is, the application of microwave energy to heat the water passing though the heat exchange chamber 12, and recovers power which is lost in the form of heat from the magnetron 18.

While the preferred embodiments have been shown and described, it will be understood that there is no intent to limit the invention by such disclosure, but rather, is intended to cover all modifications and alternate constructions falling within the spirit and scope of the invention.

1. A water heating system, comprising:
a heat exchange chamber having an internal cavity;
a water coil within the internal cavity of the heat exchange chamber;
a magnetron generating microwave energy in communication with the internal cavity;
a hot air control system drawing the heat generated by the magnetron into the internal cavity; the hot air control system includes a valve which is selectively opened and closed to control the passage of the heat generated by the magnetron through the internal cavity.

2. The water heating system according to claim 1, further including a microwave stirring fan distributing microwave energy generated by the magnetron.

3. The water heating system according to claim 1, wherein the water coil includes an inlet and an oulet, and temperature sensors are respectively positioned at the inlet and outlet for monitoring water temperatures.

4. The water heating system according to claim 1, further including a microprocessor controlling operation of the water heating system.

5. The water heating system according to claim 1, wherein the water coil is helically oriented within the internal cavity.

6. The water heating system according to claim 1, wherein the water coil is composed of PTFE tubing.

7. The water heating system according to claim 1, wherein the valve is a butterfly valve.

8. The water heating system according to claim 1, wherein a solenoid control the valve.

9. The water heating system according to claim 1, wherein the valve is opened when the magnetron is powered on generating microwave energy and the valve is closed when the magnetron is powered off.

10. The water heating system according to claim 1, wherein the magnetron is coupled to a wave guide which directs the microwave energy from the magnetron to the internal cavity.

11. The water heating system according to claim 1, wherein the wave guide includes an inlet end coupled to the magnetron and an outlet end to which a microwave stirring fan is coupled for distributing microwave energy as it enters the internal cavity.
